(19) United States
(12) Patent Application Publication
(10) Pub. No.: US 2024/0329258 A1
(43) Pub. Date: Oct. 3, 2024

(54) POSITIONING DEVICE AND POSITIONING METHOD

(71) Applicant: NIPPON TELEGRAPH AND TELEPHONE CORPORATION, Tokyo (JP)

(72) Inventors: Hiroshi CHIGIRA, Tokyo (JP); Masafumi SUZUKI, Tokyo (JP)

(73) Assignee: NIPPON TELEGRAPH AND TELEPHONE CORPORATION, Tokyo (JP)

(21) Appl. No.: 18/576,309

(22) PCT Filed: Jul. 5, 2021
(86) PCT No.: PCT/JP2021/025370

§ 371 Date: Jan. 3, 2024

(51) Int. Cl. G01S 19/36; G01S 19/22; G01S 19/39

(52) U.S. Cl. CPC G01S 19/36; G01S 19/22; G01S 19/396

(57) ABSTRACT

A positioning device (1) according to the present invention includes an antenna (11) that is mounted on a mobile object (3) and receives radio waves from a satellite, a positioning unit (12) that calculates a positioning result and positioning accuracy on the basis of radio waves received by the antenna (11), an antenna position changing unit (13) that changes a position of the antenna (11), an antenna position detection unit (14) that detects a relative position of the antenna (11) with respect to the mobile object (3) after changing the position of the antenna (11), and a control unit (15) that controls the position of the antenna (11) and determines a position of the mobile object (3) on the basis of the positioning result and the relative position in a case where the positioning accuracy is equal to or more than a threshold.

### TECHNICAL FIELD

The present disclosure relates to a positioning device and a positioning method that perform satellite positioning.

### BACKGROUND ART

Conventionally, a global navigation satellite system (GNSS) using radio waves from a satellite is widely used as a means for detecting position information (that is, positioning) of an automobile, a robot, or the like. For example, Patent Literature 1 describes a navigation satellite system receiver capable of achieving highly accurate time synchronization and positioning even in an environment where a reception state of navigation satellite signals is poor.

### CITATION LIST

### Patent Literature

Patent Literature 1: JP 2020-201282 A

### SUMMARY OF INVENTION

### Technical Problem

However, when satellite positioning by GNSS is implemented, radio waves (direct waves) from a satellite may be shielded by an obstacle such as a building and may not be received. In addition, direct waves may be reflected or diffracted by an obstacle such as a building, and a multipath received as reflected waves and diffracted waves may cause a delay in arrival time of radio waves and an error in a positioning result.

An object of the present disclosure made in view of such circumstances is to provide a positioning device and a positioning method that achieve stable positioning by changing a position of an antenna at a time of performing satellite positioning to reduce influences of shielding of radio waves and multipaths.

### Solution to Problem

In order to solve the above problem, a positioning device according to a first embodiment is a positioning device that detects a position of a mobile object, the positioning device including an antenna that is mounted on the mobile object and receives radio waves from a satellite, a positioning unit that calculates a positioning result (referring to position information of the mobile object) and positioning accuracy (referring to a range (for example, 5 m error) in which an error of the position information of the mobile object is contained) on the basis of radio waves received by the antenna, an antenna position changing unit that changes a position of the antenna, an antenna position detection unit that detects a relative position of the antenna with respect to the mobile object after changing the position of the antenna, and a control unit that controls the position of the antenna and determines the position of the mobile object on the basis of the positioning result and the relative position in a case where the positioning accuracy is equal to or more than a threshold.

In order to solve the above problem, a positioning method according to the first embodiment is a positioning method in a positioning device that detects a position of a mobile object, the positioning method including, by the positioning device, a step of receiving radio waves from a satellite, a step of calculating a positioning result and positioning accuracy on the basis of received radio waves, a step of changing a position of an antenna, a step of detecting a relative position of the antenna with respect to the mobile object after changing the position of the antenna, and a step of controlling the position of the antenna and determining the position of the mobile object on the basis of the positioning result and the relative position in a case where the positioning accuracy is equal to or more than a threshold.

### Advantageous Effects of Invention

According to the present disclosure, it is possible to achieve stable positioning by changing a position of an antenna at a time of performing satellite positioning to reduce influences of shielding of radio waves and multipaths.

### BRIEF DESCRIPTION OF DRAWINGS

FIG. 1 is a block diagram illustrating a configuration example of a positioning device according to a first embodiment.

FIG. 2 is a schematic diagram of the positioning device according to the first embodiment.

FIG. 3 is a schematic diagram illustrating a mechanism for changing a position of an antenna in a three-dimensional direction.

FIG. 4 is a schematic diagram illustrating a change in a position of an antenna for reducing influences of shielding of radio waves.

FIG. 5 is a flowchart illustrating an example of a positioning method executed by the positioning device according to the first embodiment.

FIG. 6 is a block diagram illustrating a configuration example of a positioning device according to a second embodiment.

FIG. 7 is a flowchart illustrating an example of a positioning method executed by the positioning device according to the second embodiment.

### DESCRIPTION OF EMBODIMENTS

Hereinafter, modes for carrying out the present invention will be described in detail with reference to the drawings. The present invention is not limited to the embodiment described below, and various modifications can be made within the scope of the gist of the present invention.

### First Embodiment

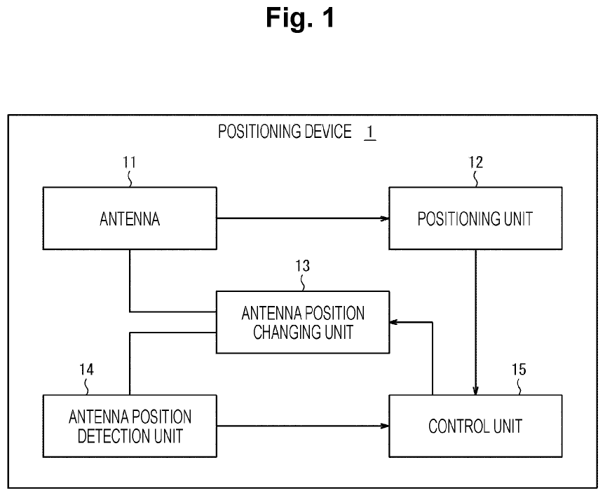

FIG. 1 is a block diagram illustrating a configuration example of a positioning device 1 according to a first embodiment. As illustrated in FIG. 1, the positioning device 1 according to the first embodiment includes an antenna 11, a positioning unit 12, an antenna position changing unit 13, an antenna position detection unit 14, and a control unit 15. The positioning device 1 is mounted on a mobile object and detects a position of the mobile object.

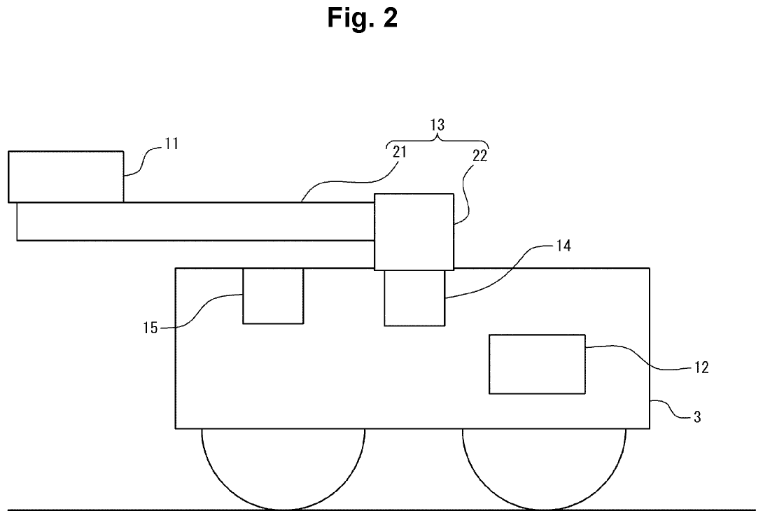

FIG. 2 is a schematic diagram of the positioning device 1 mounted on the mobile object. As illustrated in FIG. 2, the mobile object 3 includes the positioning unit 12, the antenna position detection unit 14, and the control unit 15. The antenna position detection unit 14 is mounted at a center portion of the mobile object 3, a motor 22 is joined to an upper portion of the antenna position detection unit 14, and one end of an arm 21 is joined to the motor 22. The antenna position changing unit 13 includes the arm 21 and the motor 22, and changes the position of the antenna 11 mounted on one end of the arm 21 according to rotation of the motor 22.

The mobile object 3 is a vehicle, a robot, or the like achieved using a known technique.

The antenna 11 is an antenna mounted on the mobile object 3 that receives radio waves from satellites for satellite positioning. The antenna 11 transmits radio waves received from a satellite to the positioning unit 12.

The positioning unit 12 calculates a positioning result and positioning accuracy on the basis of the radio waves received by the antenna 11. The positioning unit 12 is a general positioning device, and is only required to be a device that can perform positioning using the radio waves received by the antenna 11 and acquire position information (positioning result) of the mobile object 3 and accuracy (positioning accuracy) of the position information. Here, the positioning unit 12 implements positioning using a known technology, and for example, single positioning, a differential global positioning system (DGPS), a real-time kinematic global positioning system (RTK-GPS), and the like can be considered as a positioning method, but the positioning method is not limited to these methods. Further, in a case where DGPS, RTKGPS, or the like is used, the positioning unit 12 includes a reception device for receiving correction information necessary for positioning. In addition, as accuracy of the position information, for example, indexes such as the number of visible satellites, horizontal dilution of precision (HDOP), and vertical dilution of precision (VDOP) are conceivable, but it is sufficient if the positioning unit 12 has a function capable of determining the quality of the state when receiving radio waves from a satellite without depending on these indexes. Here, a good reception state may be displayed by, for example, a character string such as “the radio waves are/are not by multipaths” or “good accuracy is/is not obtained”. The positioning unit 12 may have a multipath detection function. The positioning unit 12 transmits the calculated positioning accuracy and positioning result to the control unit 15.

The antenna position changing unit 13 changes the position of the antenna 11 on the basis of the instruction transmitted from the control unit 15. As illustrated in FIG. 2, the antenna position changing unit 13 includes the arm 21 in which the antenna 11 is mounted at one end and the other end is joined to the motor 22, and the motor 22 mounted at the center portion of the mobile object 3, and changes the position of the antenna 11 in a horizontal direction according to the rotation of the motor 22.

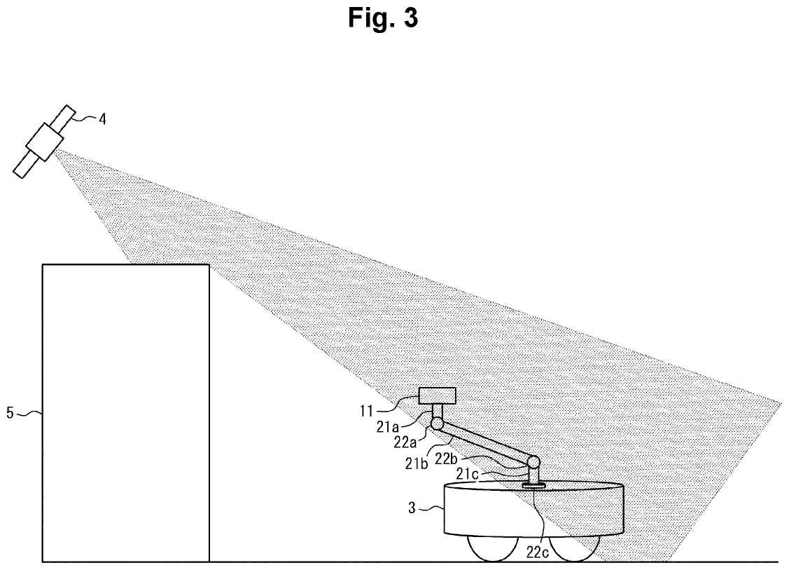

As illustrated in FIG. 3, the antenna position changing unit 13 may include a mechanism that includes a plurality of arms 21a, 21b, and 21c and a plurality of motors 22a, 22b, and 22c, and changes the position of the antenna 11 in a three-dimensional direction according to the rotation of the motor 22. Since the antenna position changing unit 13 includes the mechanism, it is possible to change the antenna height to a position at which radio waves are shielded or the influence of multipaths is reduced.

The antenna position detection unit 14 detects a relative position of the antenna 11 with respect to the mobile object 3 after the antenna position changing unit 13 changes the position of the antenna 11. As illustrated in FIG. 2, the antenna position detection unit is disposed below the motor 22 and is joined to the motor 22. The antenna position detection unit 14 is a rotary encoder, detects the angle of the motor 22, and detects a relative change in the position of the antenna 11 on the basis of the length of the arm 21 stored in advance. That is, assuming that the length of the arm 21 is r, the relative position (X, Y) of the antenna 11 with respect to the center position of the mobile object 3 is acquired by the following Expressions (1) and (2). The antenna position detection unit 14 transmits the relative position to the control unit 15.

[Math. 1]

X=r cos θ (1)

Y=r sin θ (2)

The control unit 15 controls the position of the antenna 11, and determines the position of the mobile object 3 on the basis of the positioning result and the relative position in a case where the positioning accuracy is equal to or more than a threshold. The control unit 15 determines the position of the mobile object 3 by subtracting the relative position detected by the antenna position detection unit 14 from the positioning result calculated by the positioning unit 12. The threshold refers to a reference value for determining a position at which the positioning accuracy is improved.

For example, when the motor 22 is changed by 1° at intervals of 0.1 seconds from 0° to 360° with respect to the antenna position changing unit 13, the control unit 15 acquires 360 types of positioning results and relative positions corresponding to the change by 1°. By comparing the 360 types of positioning results and the positioning accuracy calculated on the basis of the relative position, a position where the positioning accuracy is equal to or more than a predetermined threshold is determined. The position where the positioning accuracy is equal to or more than the predetermined threshold may be a position where the positioning accuracy is the highest. However, the time interval or angle width of the change is not limited thereto. That is, after determining the position where the positioning accuracy is the highest, the control unit 15 moves the antenna 11 to the position using the antenna position changing unit 13. In this manner, the control unit 15 may change the motor by a predetermined angle from 0° to 360°, and determine the position of the mobile object on the basis of the positioning result and the relative position in a case where the positioning accuracy is the highest.

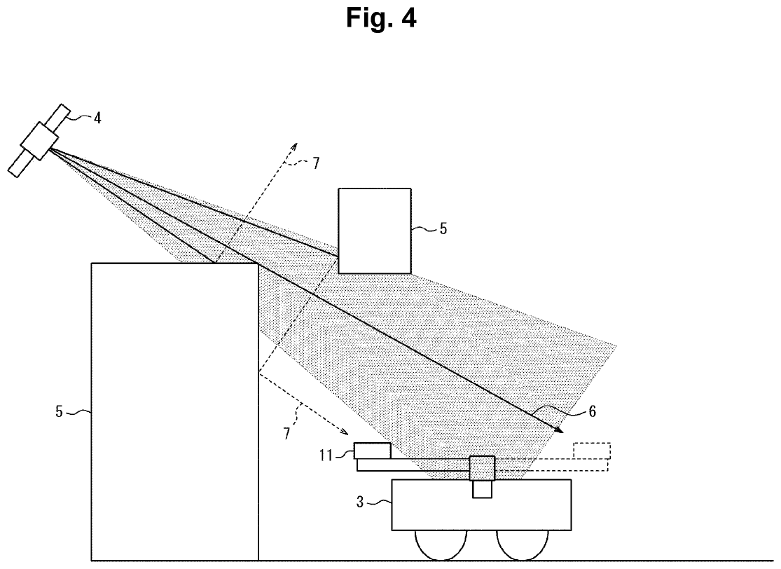

According to the present disclosure, when the mobile object 3 is stationary, good positioning can be achieved by changing the position of the antenna 11 so that the radio wave receiving state of the antenna 11 becomes good. For example, in a case where the number of visible satellites (referring to the number of satellites capable of receiving radio waves as direct waves) is 30, it is assumed that good positioning can be achieved. As illustrated in FIG. 4, when the antenna 11 is at the position indicated by solid lines, the radio waves from a satellite 4 are shielded by an obstacle 5 such as a building, and the antenna 11 cannot receive the direct waves 6 from the satellite 4, resulting in a reduction in the number of visible satellites by one. However, when the position of the antenna 11 is changed by 180° and moved to the position indicated by broken lines, the antenna 11 can receive the direct waves 6 from the satellite 4, so that the number of visible satellites is not reduced, and the positioning unit 12 can maintain good positioning.

Further, as illustrated in FIG. 4, reflected waves 7 (multipaths) may be received when the antenna 11 is located at a position indicated by the solid lines, and the direct waves 6 may be received when the antenna 11 is located at the position indicated by the broken lines. In such a situation, in a case where the positioning unit 12 has a multipath detection function, if it is determined by the detection function that “the radio waves are the reflected waves 7” when the antenna 11 is at the position indicated by the solid lines, and it is determined that “the radio waves are the direct waves 6” when the antenna 11 is at the position indicated by the broken lines, good positioning can be achieved by moving the antenna 11 to the position indicated by the broken lines.

As described above, while changing the position of the antenna 11 by the antenna position changing unit 13, the positioning device 1 determines the position of the antenna 11 to be changed on the basis of the positioning accuracy calculated by the positioning unit 12, and determines the position of the mobile object 3 on the basis of the positioning result calculated by the positioning unit 12 and the position of the antenna 11 detected by the antenna position detection unit 14.

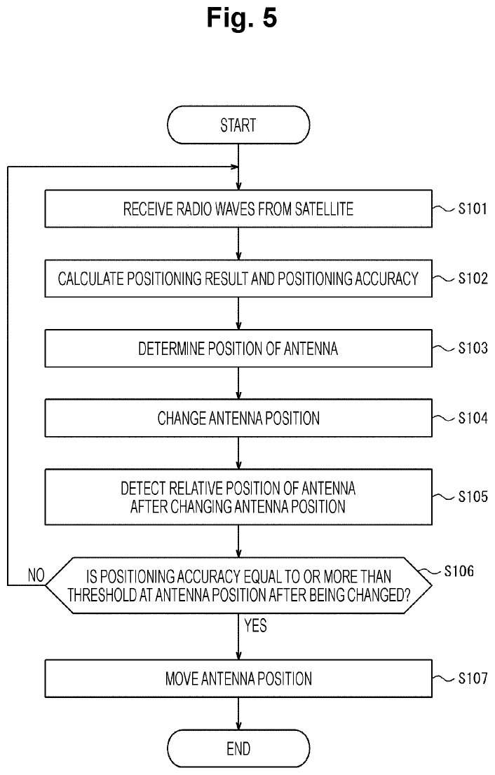

FIG. 5 is a flowchart illustrating an example of a positioning method executed by the positioning device 1.

In step S101, the antenna 11 receives radio waves from the satellite 4.

In step S102, the positioning unit 12 calculates the positioning result and positioning accuracy.

In step S103, the control unit 15 determines the position of the antenna 11 to be changed.

In step S104, the antenna position changing unit 13 changes the position of the antenna 11.

In step S105, the antenna position detection unit 14 detects the relative position of the antenna 11 with respect to the mobile object 3 after changing the position of the antenna 11.

In step S106, the control unit 15 determines whether or not the positioning accuracy is equal to or more than the threshold at the position of the antenna 11 after being changed.

In step S107, the antenna position changing unit 13 moves the antenna 11 to a position where the positioning accuracy is equal to or more than the threshold.

By performing such processing, the positioning device 1 according to the present disclosure receives radio waves by reducing the influences of shielding of radio waves and multipaths, and achieves good positioning.

### Second Embodiment

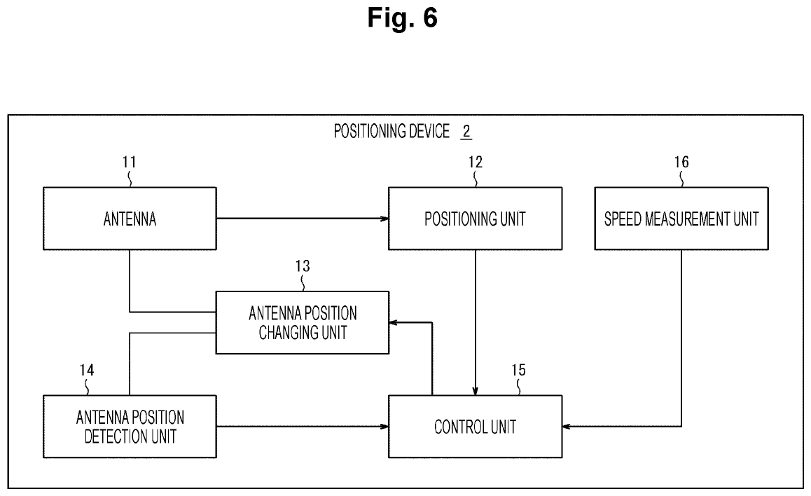

Next, an example in which the position of the antenna is determined in a state where the mobile object is moving will be described as a second embodiment. FIG. 6 is a block diagram illustrating a configuration example of the positioning device 2 according to the second embodiment. The positioning device 2 illustrated in FIG. 6 includes the antenna 11, the positioning unit 12, the antenna position changing unit 13, the antenna position detection unit 14, the control unit 15, and a speed measurement unit 16. The positioning device 2 is different in further including the speed measurement unit 16 as compared with the positioning device 1 according to the first embodiment. The same components as those of the first embodiment will be denoted by the same reference signs as those of the first embodiment, and the description thereof will be omitted as appropriate.

The speed measurement unit 16 is provided inside the mobile object 3 and measures the speed at which the mobile object 3 moves. The speed measurement unit 16 transmits the measured moving speed of the mobile object 3 to the control unit 15. The control unit 15 determines a speed at which the antenna position changing unit 13 changes the position of the antenna 11 on the basis of the moving speed, and instructs the antenna position changing unit 13 to change the position of the antenna 11. For example, when the mobile object 3 is moving in a certain direction at a speed of 1 m/s, the antenna position changing unit 13 rotates the motor 22 (that is, the antenna 11) at a speed higher than the moving speed of the mobile object 3, such as five rotations/s, so that the antenna position at which the positioning accuracy becomes good can be sufficiently searched for.

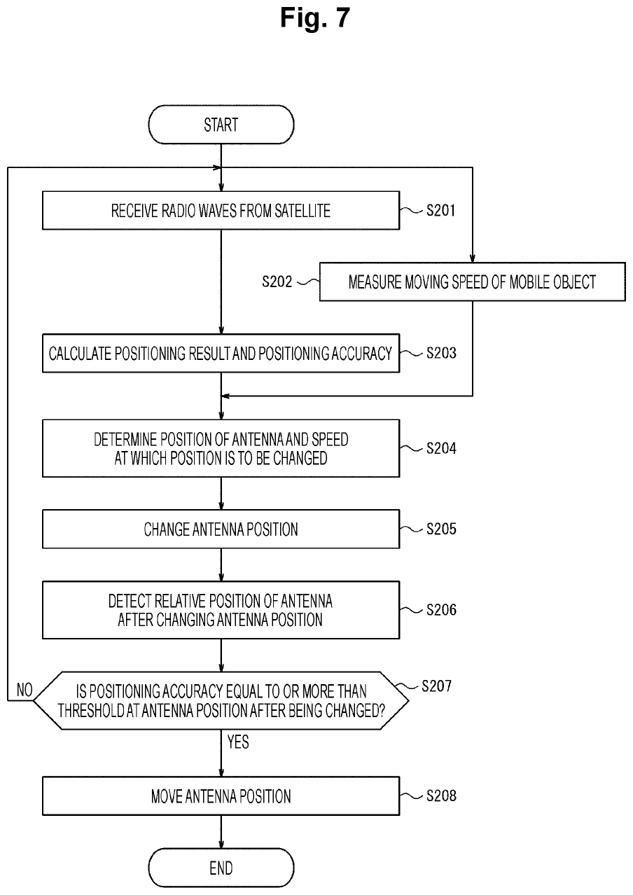

FIG. 7 is a flowchart illustrating an example of a positioning method executed by the positioning device 2.

In step S201, the antenna 11 receives radio waves from the satellite 4.

In step S202, the speed measurement unit 16 measures the moving speed of the mobile object 3.

In step S203, the positioning unit 12 calculates the positioning result and the positioning accuracy.

In step S204, the control unit 15 determines the position of the antenna 11 to be changed and the speed at which the position of the antenna 11 is to be changed.

In step S205, the antenna position changing unit 13 changes the position of the antenna 11.

In step S206, the antenna position detection unit 14 detects the relative position of the antenna 11 with respect to the mobile object 3 after changing the position of the antenna 11.

In step S207, the control unit 15 determines whether or not the positioning accuracy is equal to or more than the threshold at the position of the antenna 11 after being changed.

In step S208, the antenna position changing unit 13 moves the antenna 11 to a position where the positioning accuracy is equal to or more than the threshold.

By performing such processing, the positioning device 2 according to the present disclosure receives radio waves while reducing the influences of shielding of radio waves and multipaths even in a state where the mobile object 3 is moving, and achieves good positioning.

With regard to the above embodiment, the following supplementary notes are further disclosed.

### (Supplementary Note 1)

A positioning device that detects a position of a mobile object, the positioning device including:
a control unit that receives radio waves from a satellite, calculates a positioning result and positioning accuracy on the basis of the received radio waves, changes a position of the antenna, detects a relative position of the antenna with respect to the mobile object after changing the position of the antenna, and controlling a position of the antenna and determining the position of the mobile object on the basis of the positioning result and the relative position in a case where the positioning accuracy is equal to or more than a threshold.

### (Supplementary Note 2)

The positioning device according to supplementary note 1, in which
the control unit
includes a motor, and changes a position of the antenna in a horizontal direction according to rotation of the motor.

### (Supplementary Note 3)

The positioning device according to supplementary note 2, in which
the control unit
changes the motor by a predetermined angle from 0° to 360°, and determines the position of the mobile object on the basis of the positioning result and the relative position in a case where the positioning accuracy is highest.

### (Supplementary Note 4)

The positioning device according to supplementary note 1, in which
the control unit
includes a plurality of motors, and changes a position of the antenna in a three-dimensional direction according to rotation of the motor.

### (Supplementary Note 5)

The positioning device according to any one of supplementary notes 1 to 4, in which
the control unit
measures a moving speed at which the mobile object moves, and determines a speed at which the position of the antenna is changed on the basis of the moving speed.

### (Supplementary Note 6)

A positioning method for detecting a position of a mobile object, the positioning method including,
by the positioning device:
a step of receiving radio waves from a satellite; a step of calculating a positioning result and positioning accuracy on the basis of received radio waves; a step of changing a position of an antenna; a step of detecting a relative position of the antenna with respect to the mobile object after changing the position of the antenna; and a step of controlling the position of the antenna and determining the position of the mobile object on the basis of the positioning result and the relative position in a case where the positioning accuracy is equal to or more than a threshold.

Although the above-described embodiments have been described as representative examples, it is apparent to those skilled in the art that many modifications and substitutions can be made within the spirit and scope of the present disclosure. Therefore, it should be understood that the present invention is not limited by the above-described embodiments, and various modifications or changes can be made without departing from the scope of the claims. For example, a plurality of configuration blocks illustrated in the configuration diagrams of the embodiment can be combined into one, or one configuration block can be divided.

### REFERENCE SIGNS LIST

1, 2 Positioning device
3 Mobile object
4 Satellite
5 Obstacle such as building
11 Antenna
12 Positioning unit
13 Antenna position changing unit
14 Antenna position detection unit
15 Control unit
16 Speed measurement unit
21, 21a, 21b, 21c Arm
22, 22a, 22b, 22c Motor

1. A positioning device for detecting a position of a mobile object, the positioning device comprising a processor configured to execute operations comprising:
receiving, using an antenna that is mounted on the mobile object, radio waves from a satellite;
calculating a positioning result and positioning accuracy on the basis of the received radio waves;
updating a position of the antenna;
determining a relative position of the antenna with respect to the mobile object after updating the position of the antenna;
determining the position of the mobile object on the basis of the positioning result and the relative position, wherein the positioning accuracy is equal to or more than a threshold.

2. The positioning device according to claim 1, wherein the updating a position of the antenna further comprises updating the position of the antenna in a horizontal direction according to rotation of a motor.

3. The positioning device according to claim 2, wherein the determining the position of the mobile object further comprises:
updating the motor by a predetermined angle from 0° to 360°, and
determining the position of the mobile object on the basis of the positioning result and the relative position in a case where the positioning accuracy is highest.

4. The positioning device according to claim 1, wherein the updating a position of the antenna further comprises updating the position of the antenna in a three-dimensional direction according to rotation of a motor.

5. The positioning device according to claim 1, the processor further configured to execute operations comprising:
measuring a moving speed at which the mobile object moves, wherein
the determining the position of the mobile object further comprises determining a speed at which the position of the antenna is changed on the basis of the moving speed.

6. A positioning method for detecting a position of a mobile object, the positioning method comprising,
receiving radio waves from a satellite;
calculating a positioning result and positioning accuracy on the basis of the received radio waves;
updating a position of an antenna;
determining a relative position of the antenna with respect to the mobile object after updating the position of the antenna;
updating the position of the antenna; and
determining the position of the mobile object on the basis of the positioning result and the relative position, wherein the positioning accuracy is equal to or more than a threshold.

7. The positioning device according to claim 1, wherein the positioning result indicates location information of the mobile object, and the positioning accuracy indicates a degree of accuracy of the location information of the mobile object.

8. The positioning device according to claim 1, wherein the positioning accuracy is based on a quality of receiving the radio waves.

9. The positioning device according to claim 1, wherein the mobile object is stationary.

10. The positioning device according to claim 1, wherein the mobile object is in motion.

11. The positioning device according to claim 1, wherein the antenna is movable by using at least an arm in a three-dimensional direction according to a rotation of a motor.

12. The positioning method according to claim 6, wherein the updating a position of the antenna further comprises updating the position of the antenna in a horizontal direction according to rotation of a motor.

13. The positioning method according to claim 12, wherein the determining the position of the mobile object further comprises:
updating the motor by a predetermined angle from 0° to 360°, and
determining the position of the mobile object on the basis of the positioning result and the relative position in a case where the positioning accuracy is highest.

14. The positioning method according to claim 6, wherein the updating a position of the antenna further comprises updating the position of the antenna in a three-dimensional direction according to rotation of a motor.

15. The positioning method according to claim 6, further comprising:
measuring a moving speed at which the mobile object moves, wherein
the determining the position of the mobile object further comprises determining a speed at which the position of the antenna is changed on the basis of the moving speed.

16. The positioning method according to claim 6, wherein the positioning result indicates location information of the mobile object, and the positioning accuracy indicates a degree of accuracy of the location information of the mobile object.

17. The positioning method according to claim 6, wherein the positioning accuracy is based on a quality of receiving the radio waves.

18. The positioning method according to claim 6, wherein the mobile object is stationary.

19. The positioning method according to claim 6, wherein the antenna is movable by using at least an arm in a three-dimensional direction according to a rotation of a motor.

20. The positioning method according to claim 6, wherein the updating a position of the antenna further comprises updating the position of the antenna in a horizontal direction according to rotation of a motor.
